(19) United States
(12) Patent Application Publication
(10) Pub. No.: US 2006/0290179 A1
(43) Pub. Date: Dec. 28, 2006

(54) Saddle seat assembly

(76) Inventor: John D. Reinhard, Corona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/329,794

(22) Filed: Jan. 11, 2006

Related U.S. Application Data
(60) Provisional application No. 60/689,210, filed on Jun. 10, 2005.

(51) Int. Cl. B62J 1/00

(52) U.S. Cl. 297/215.11

(57) ABSTRACT

A saddle-style seat assembly comprises removable backrests. At least one of the backrests can be made foldable such that the backrest can be folded during mounting of the seat. The backrest is supported with a folding backrest assembly. The folding backrest assembly can have a hinge point that is located internally of the saddle.

### CROSS-REFERENCE TO RELATED APPLICATIONS

The present application is based on and claims the benefit priority under 35 U.S.C. § 119 to U.S. Provisional Application No. 60/689,210, filed on Jun. 10, 2005, the entire contents of which is expressly incorporated by reference herein.

### BACKGROUND OF THE INVENTION

1. Field of the Invention

The present invention generally relates to vehicle seats. More particularly, the present invention relates to tandem vehicle seats having removable backrests.

2. Description of the Related Art

Cruisers are a type of motorcycle commonly associated with short rides down the highway or along the city streets. This type of motorcycle typically employs a stepped seat and encourages a laid-back ride. Moreover, many cruisers provide backrests to the driver portion of the seat and the passenger portion of the seat.

In some configurations, the backrests can be removed to provide a more streamlined appearance to the motorcycle and inserted to provide support for the backs of riders and passengers. When inserted, however, the backrests can increase the difficulty with which riders and passengers mount the motorcycle.

Thus, a foldable seat back has been used in the industry. While the current designs of foldable seat backs afford riders and passengers an opportunity to mount the motorcycle with the seatbacks folded down, the current designs suffer from a number of drawbacks.

### SUMMARY OF THE INVENTION

Thus, a foldable seat back has been used in the industry. While the current designs of foldable seat backs afford riders and passengers an opportunity to mount the motorcycle with the seatbacks folded down, the current designs suffer from a number of drawbacks.

One aspect of the present invention relates to the recognition of some of these drawbacks. For instance, in many folding seatback assemblies, an enlarged folding mechanism is positioned within the seat, which displaces possible padding. Thus, the amount of padding is decreased in such seats, which results in uncomfortable riding by either the driver or the passenger.

Moreover, in most removable or folding seat configurations, the backrest is rigidly supported by a support member. The support member is generally very stiff. Thus, when the motorcycle encounters rough roads or bumps, the backrest can limit driver or passenger movement. In other words, rather than cushioning the bumps, the backrest directly translates the bumps and jolts to the associated driver or passenger.

One aspect of the present invention relates to a backrest for a saddle seat assembly. The assembly comprises a backplate. The back plate is coupled to a support. The support is configured for removable insertion into a saddle seat. The support comprises a first portion and a second portion with the first portion and the second portion being pivotally connected.

Another aspect of the present invention relates to a saddle seat assembly for a vehicle. The saddle seat assembly comprises a seat base and a seat cover. A socket is positioned between the seat base and the seat cover. The socket has an upper surface through which a receptacle is defined. A seat backrest comprises a support. The support has a portion that is insertable through the seat cover into the receptacle of the socket. The portion of the support comprises a first portion and a second portion that are connected at a pivot axis. The first portion is generally horizontally offset from the second portion a first distance. The pivot axis is generally vertically spaced from the upper surface of the socket by a second distance. The upper surface of the socket is generally vertically spaced from the seat cover by a third distance. The third distance is less than or equal to a sum of the first distance and the second distance.

A further aspect of the present invention involves a saddle seat assembly for a vehicle. The saddle seat assembly comprises a seat base. The seat base has an inside surface and an outside surface. The inside surface corresponds to a side that will support a foam component. The seat base defines an intermediate recess. A first socket is positioned proximate the intermediate recess on the inside surface side of the seat base. A first backing plate is positioned proximate the intermediate recess on the outside surface side of the seat base. The first socket and the first backing plate are joined by fasteners. The first socket comprises a generally upwardly disposed opening receptacle. The receptacle is adapted to removably receive a seat back assembly.

### BRIEF DESCRIPTION OF THE DRAWINGS

These and other features, aspects and advantages of the present invention now will be described with reference to drawings of a preferred embodiment. The drawings comprise twelve figures.

FIG. 1 is a side view of a portion of a motorcycle having a saddle seating assembly that is arranged and configured in accordance with certain features, aspects and advantages of the present invention.

FIG. 2 is a schematic side view of the saddle seating assembly of FIG. 1.

FIG. 3 is a sectioned view of the saddle seating assembly taken within the region indicated by the circle 3-3 in FIG. 2.

FIG. 4 is an exploded perspective view of a socket assembly shown in FIG. 3.

FIG. 5 is a top end view of the socket assembly of FIG. 3.

FIG. 6 is an exploded perspective view of a seat back support assembly also shown in FIG. 3.

FIG. 7 is a perspective view of the socket assembly and the seat back support assembly shown coupled together.

FIG. 8 is a sectioned view of the saddle seating assembly taken within the region indicated by the circle 8-8 in FIG. 2.

FIG. 9 is an exploded perspective view of a socket assembly shown in FIG. 8.

FIG. 10 is an exploded perspective view of a seat back support assembly also shown in FIG. 8.

FIG. 11 is a perspective view of the socket assembly and the seat back support assembly shown coupled together.

FIG. 12 is a front elevation view of a seat back base usable with the assemblies shown in FIG. 7 and in FIG. 11.

### DETAILED DESCRIPTION OF THE PREFERRED EMBODIMENT

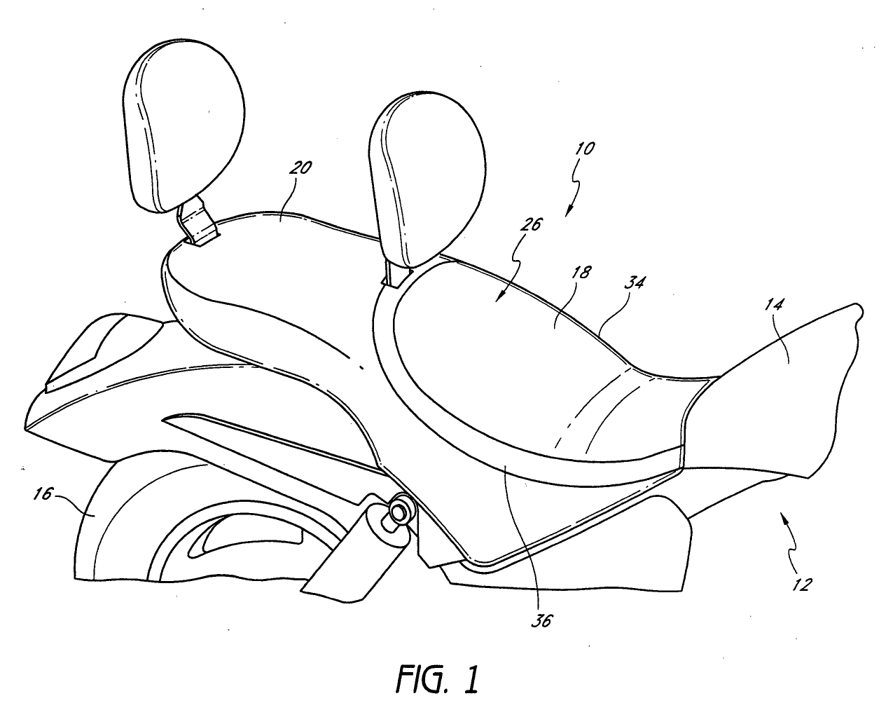

With reference now to FIG. 1, a saddle seating assembly 10 is illustrated on a portion of a motorcycle 12. The assembly 10 is shown coupled to a vehicle 12, which is a motorcycle in the illustrated embodiment but the assembly 10 can be used in conjunction with other types of vehicles. For instance, the assembly 10 can be used with personal watercraft, snowmobiles, all terrain vehicles and the like.

The assembly 10 can be secured to the vehicle 12 in any suitable manner. In the illustrated arrangement, the assembly 10 is secured to a frame rail of the vehicle 12. The assembly 10 preferably is positioned rearward of a fuel tank 14 and generally above a rear wheel 16 of the vehicle. The assembly 10 preferably is designed such that a rider and, in some configurations, a passenger can be seated in straddle-fashion on the assembly 10. In one preferred configuration, a driver seat portion 18 is positioned forward of a passenger seat portion 20. In one more preferred configuration, the driver seat portion 18 is positioned slightly vertically lower than the passenger seat portion 20 with an intermediate region defined between the driver seat portion 18 and the passenger seat portion 20.

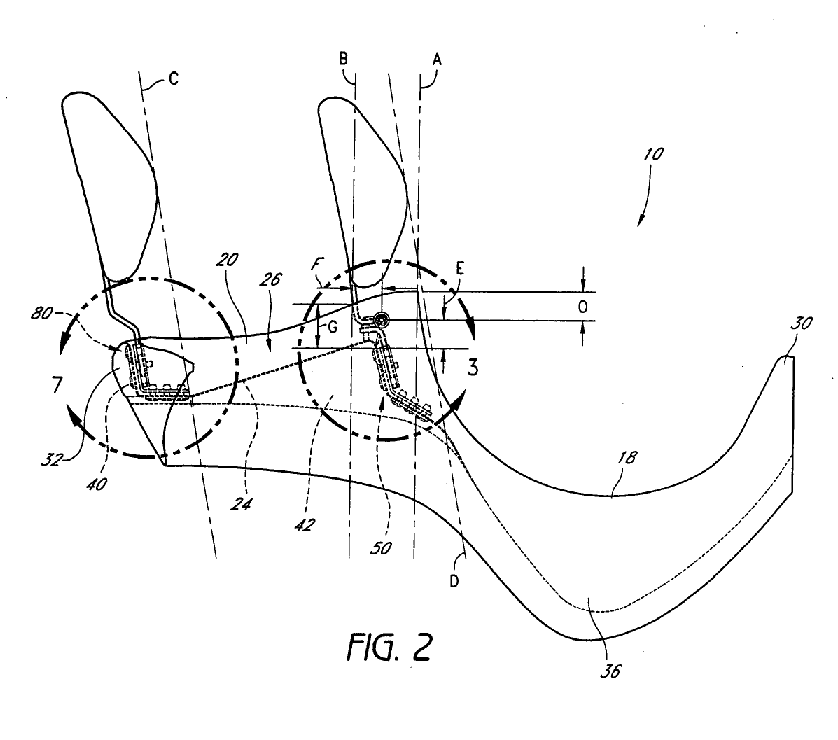

With reference now to FIG. 2, the illustrated assembly 10 generally comprises a substantially rigid underplate, seat pan, platform or base member 24 that extends under at least a portion of a saddle 26. The base member 24 can be formed of any suitable material. In some applications, the base member 24 is formed of fiberglass. In one preferred arrangement, the base member 24 is formed by hand-laid fiberglass. Other materials, including but not limited to, metals, plastics, carbon fiber materials and the like also can be used. The base member 24 can be contoured as desired or as deemed necessary (e.g., to accommodate structures used on the vehicle such as air cleaners or the like). Furthermore, the base member 24 can be formed of multiple components that may or may not be joined together or can be defined by a single monolithic structure.

Preferably, the base member 24 extends from a forward end 30 to a rearward end 32 of the saddle 26. More preferably, the base member 24 also extends laterally from a left side 34 to a right side 36 of the saddle 16. In the illustrated arrangement, a rear recess 40 and an intermediate recess 42 are defined by the base member 24. The rear recess 40 can be defined within a rearward facing surface of the base member 24 while the intermediate recess 42 is positioned below a portion of the passenger seat portion 20 and at least a portion the intermediate region 22.

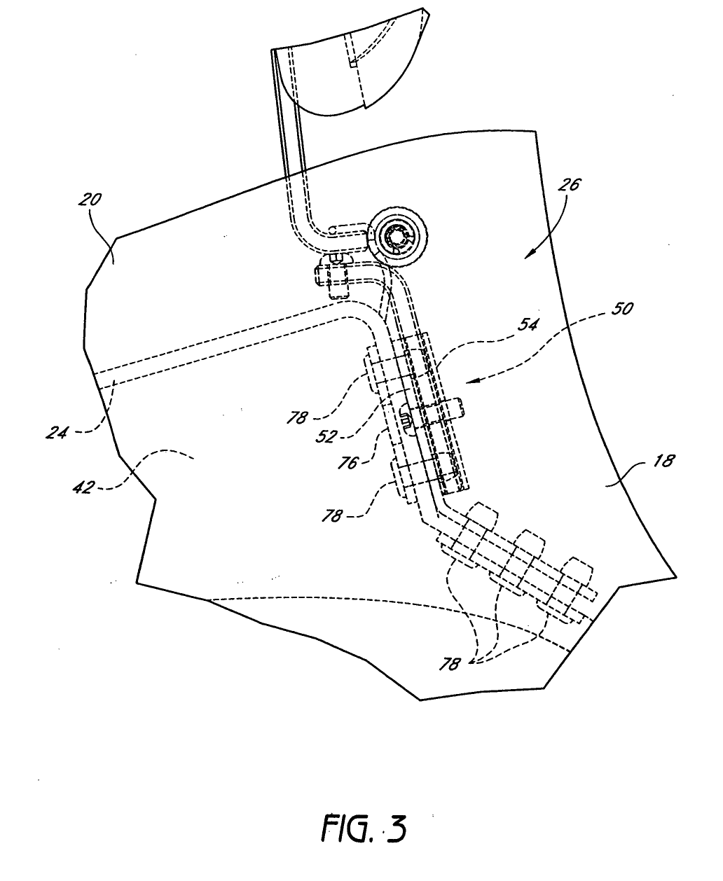

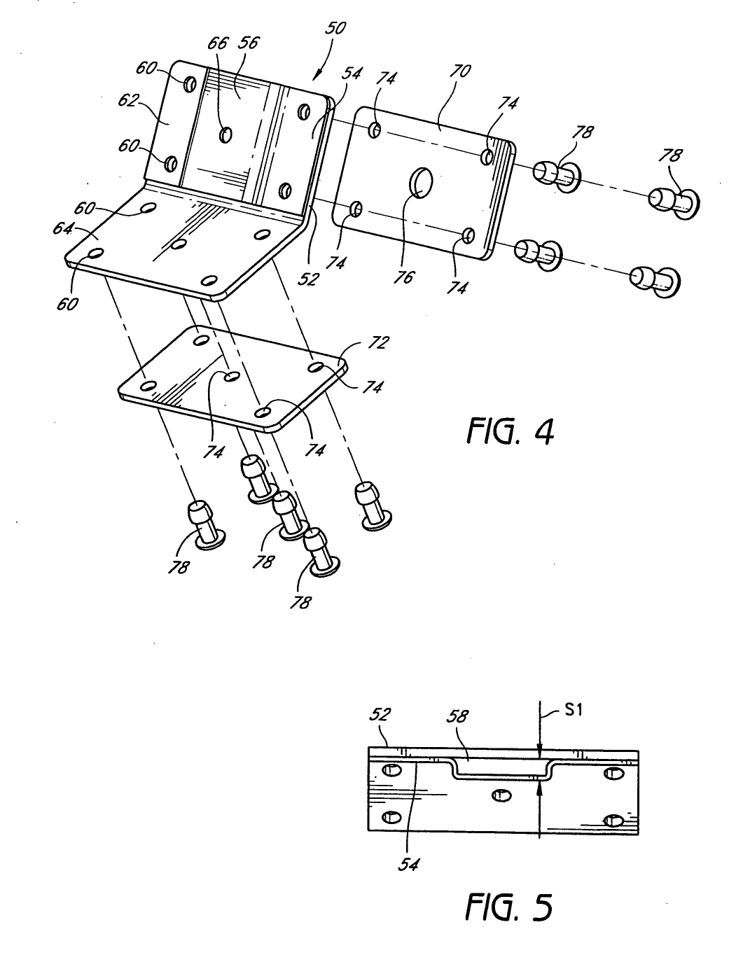

With reference now to FIG. 3, a first socket 50 is secured to the base member 24 in the vicinity of the intermediate recess 42. As shown in FIG. 4, in the illustrated arrangement, the first socket 50 comprises an angled base plate 52 and a pocket plate 54. The angled base plate 52 and the pocket plate 54 can be secured together in any suitable manner. In the illustrated arrangement, the two plates 52, 54 are welded together. In one preferred arrangement, the two plates 52, 54 are welded with a flare-V weld along the outer edges of the plates 52, 54.

The pocket plate 54 advantageously has an offset portion 56 located along its center region such that a receptacle 58 (see FIG. 5) is defined between the two plates 52, 54. In one arrangement, the opening defining the receptacle 58 has a first dimension S1 that is less than about 10 mm. In a more preferred arrangement, the first dimension S1 is less than about 8.2 mm. In an even more preferred arrangement, the first dimension S1 is less than or equal to about 6.9 mm. Preferably, the first dimension S1 extends in a fore and aft direction of the vehicle 12 (i.e., along a generally longitudinally extending plane).

In the illustrated arrangement, mounting holes 60 are defined in the first socket 50. In the illustrated arrangement, the first socket 50 comprises an upper portion 62 and a lower portion 64 that are positioned at an angle relative to each other. Each of the upper portion 62 and the lower portion 64 has a plurality of the mounting holes 60 in the illustrated arrangement. In one preferred arrangement, four mounting holes 60 extend through the upper portion 62 and five mounting holes extend through the lower portion 64. Moreover, two aligned holes 66 (one shown) are defined through the upper portion 62 such that the common centerline of the holes 66 extends through the receptacle 58.

An upper backing plate 70 and a lower backing plate 72 are provided to secure the first socket 50 in position along the base member 24. The backing plates 70, 72 preferably comprise mounting holes 74 that align with the mounting holes 60 of the upper and lower portions 62, 64 of the first socket 50. Moreover, the upper backing plate 70, which generally corresponds with the upper portion 62 of the first socket, advantageously comprises an enlarged opening 76 for reasons that will become apparent.

The first socket 50 can be positioned on an inside of the base member 24 of the seating assembly 10 (i.e., the region that will receive a foam cushion) with the upper backing plate 70 and the lower backing plate 72 being positioned on the opposite side of the base member 24 such that the base member 24 is interposed between the first socket 50 and the upper and lower backing plates 70, 72. The upper and lower backing plates 70, 72 and the first socket 50 can be secured together in any suitable manner. In one preferred arrangement, the components are secured with pop rivets 78. In other arrangements, the components can be secured by bolts, snap-fit couplers, mechanical interlocking features or the like. Advantageously, because the mounting holes 60 that receive the pop rivets 78 extend through the base plate 52 and the pocket plate 54, the pop rivets 78 further increase the strength of the connection between the components that define the receptacle 58. This is advantageous because, when a seat back is in use (i.e., mounted to the receptacle 58), the receptacle 58 is susceptible to frequent cyclical forces. Thus, reinforcing the welded connection with a mechanical fastener provides the receptacle 58 with enhanced structural integrity.

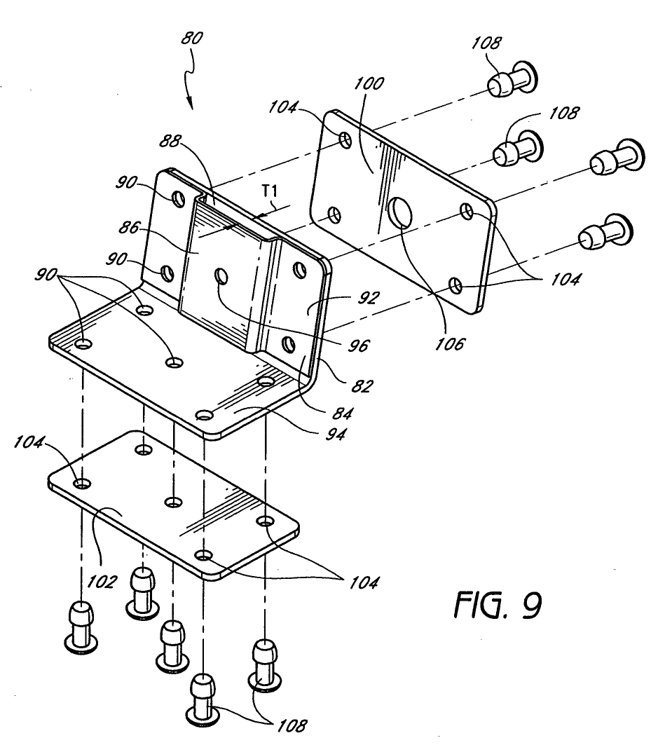

With reference again to FIG. 2, a second socket 80 is secured to the base member 24 in the vicinity of the rear recess 40. As shown in FIG. 9, in the illustrated arrangement, the second socket 80 comprises an angled base plate 82 and a pocket plate 84, in a manner similar to the first socket 50. The angled base plate 82 and the pocket plate 84 can be secured together in any suitable manner. In the illustrated arrangement, the two plates 82, 84 are welded together. In one preferred arrangement, the two plates 82, 84 are welded with a flare-V weld along the outer edges of the plates 82, 84.

The pocket plate 84 advantageously has an offset portion 86 located along its center region such that a receptacle 88 is defined between the two plates 82, 84. In one arrangement, the opening defining the receptacle 88 has a first dimension T1 that is less than about 10 mm. In a more preferred arrangement, the first dimension T1 is less than about 8.2 mm. In an even more preferred arrangement, the first dimension T1 is less than or equal to about 6.9 mm. Preferably, the first dimension T1 extends in a fore and aft direction of the vehicle 12.

In the illustrated arrangement, the second socket 80 comprises an upper portion 92 and a lower portion 94 that are positioned at an angle relative to each other. While the upper portion 92 and the lower portion 94 have a more acute enclosed angle defined between them than the upper and lower portions 62, 64 of the first socket 50, in some applications the first socket 50 can be used in place of the second socket 80 or the second socket 80 can be used in place of the first socket 50. Advantageously, however, by providing two different sockets 50, 80, two different sized or shaped receptacles 58, 88 can be formed such that interchangeability of components between the first and second sockets 50, 80 can be limited. For instance, in one configuration, the receptacle 58 of the first socket 50 has a greater dimension than receptacle 88 of the second socket 80 in one direction while the receptacle 88 of the second socket 80 has a greater dimension than the receptacle 58 of the first socket 50 in another generally perpendicular direction. Such a configuration reduces the likelihood or prevents a user from interchanging the backrests with one another.

Each of the upper portion 92 and the lower portion 94 has a plurality of mounting holes 90 in the illustrated arrangement. In one preferred arrangement, four mounting holes 90 extend through the upper portion 92 and five mounting holes 90 extend through the lower portion 94. Moreover, two aligned holes 96 (one shown) are defined through the upper portion 92 such that the common centerline of the holes 96 extends through the receptacle 88.

An upper backing plate 100 and a lower backing plate 102 are provided to secure the second socket 80 in position along the base member 24. The backing plates 100, 102 preferably comprise mounting holes 104 that align with the mounting holes 90 of the upper and lower portions 92, 94 of the second socket 80. Moreover, the upper backing plate 100, which generally corresponds with the upper portion 92 of the second socket 80, advantageously comprises an enlarged opening 106 for reasons that will become apparent.

The second socket 80 can be positioned on the inside of the base member 24 of the seating assembly 10 with the upper backing plate 100 and the lower backing plate 102 being positioned on the opposite side of the base member 24 such that the base member 24 is interposed between the second socket 80 and the upper and lower backing plates 100, 102. The upper and lower backing plates 100, 102 and the second socket 80 can be secured together in any suitable manner. In one preferred arrangement, the components are secured with pop rivets 108. In other arrangements, the components can be secured by bolts, snap-fit couplers, mechanical interlocking features or the like. As described above, the pop rivets provide enhanced structural integrity to the receptacle 88.

The backing plates 70, 72, 100, 102 advantageously increase the surface area of the base member 24 that is used to secure the sockets 50, 80 in position. Thus, the loading experienced by the pop rivets 78, 108 can be distributed over a larger surface area of the base member 24, which results in improved structural integrity to the assembly 10 relative to systems in which threaded members or bolts are merely secured in the fiberglass structure or contact the fiberglass structure only with a head region of the fastener, for example.

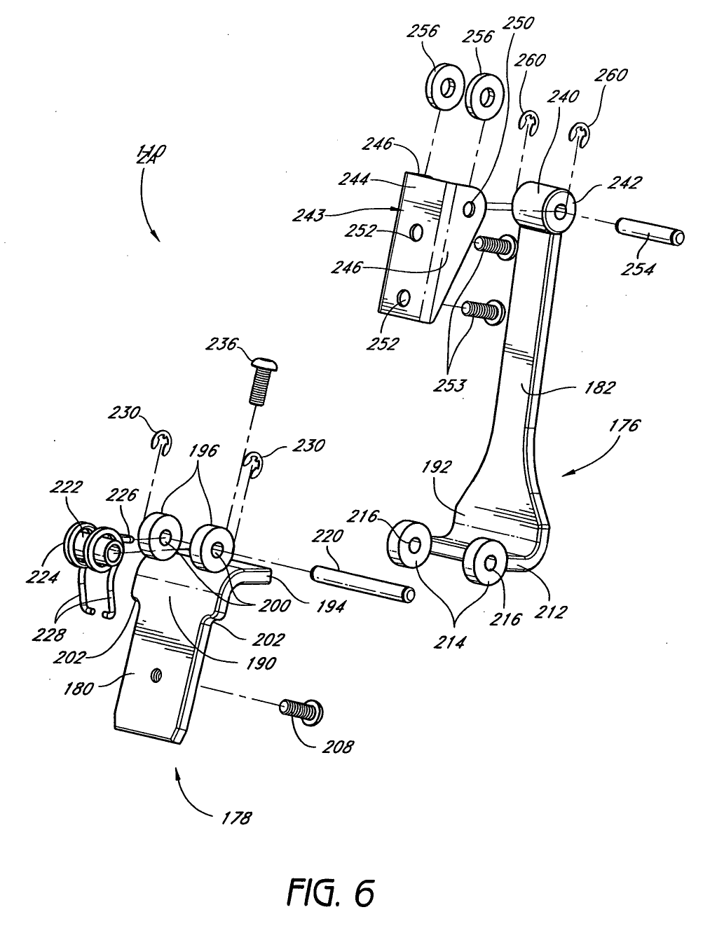

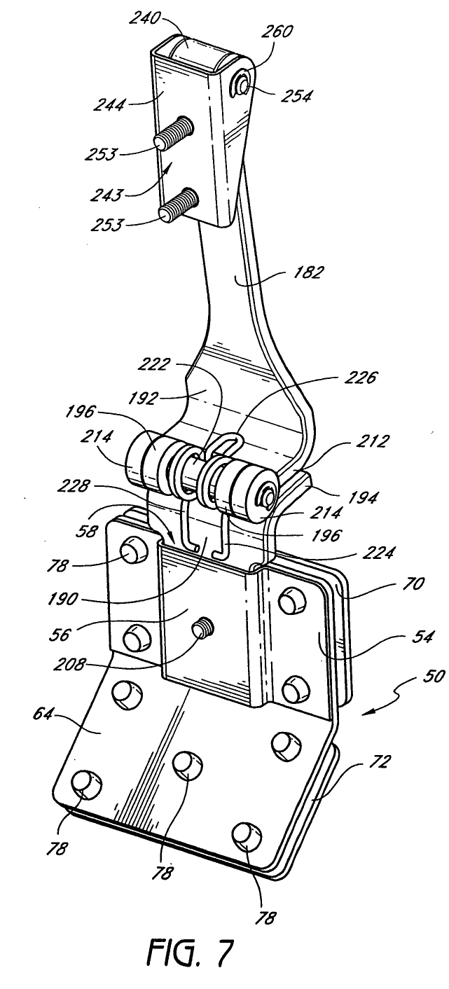

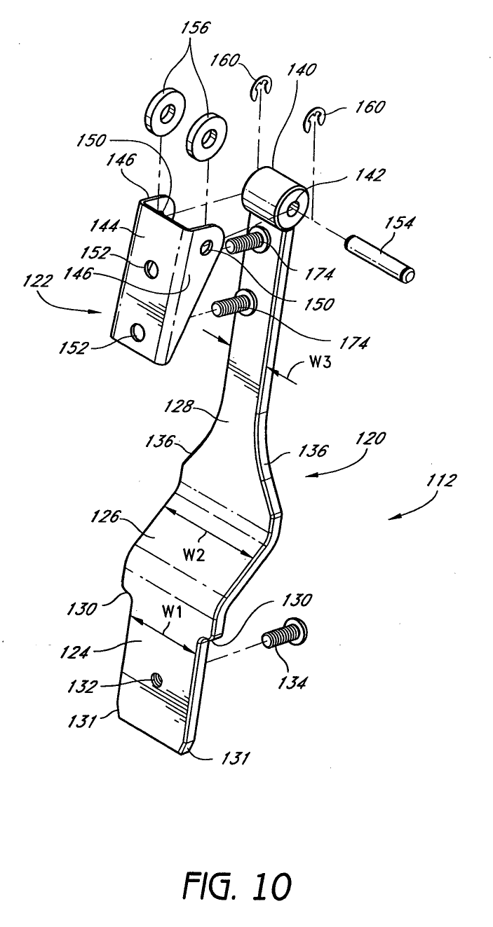

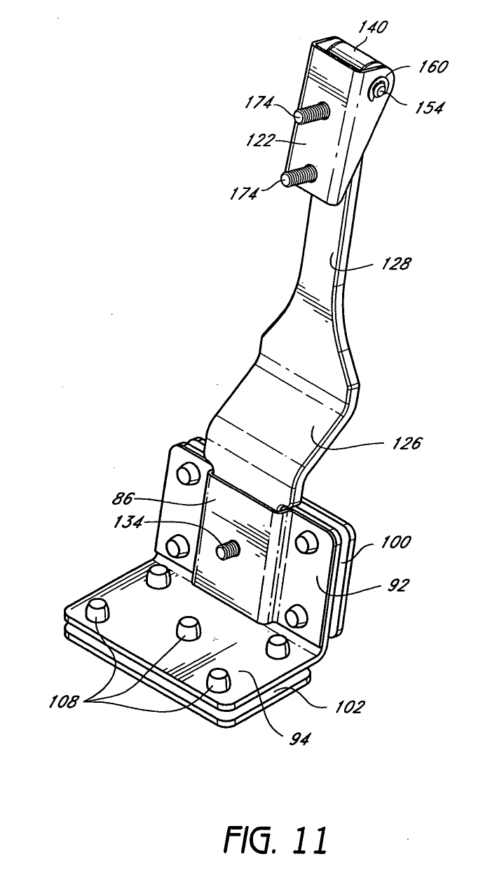

With reference now to FIGS. 6 and 10, a first backrest assembly 110 and a second backrest assembly 112 are illustrated therein. The first backrest assembly 110 is arranged and configured to connect with the first socket 50 while the second backrest assembly 112 is arranged and configured to connect with the second socket 80. In some configurations, the first and second backrest assemblies 110, 112 can be freely interchanged. In one other configuration, the first backrest assembly 110 can be interchanged with the second backrest assembly 112 while the second backrest assembly 112 cannot be interchanged with the first backrest assembly 110. In other words, in such a configuration, the first backrest assembly 110 can be connected to the first socket 50 and the second socket 80 while the second backrest assembly 112 cannot connect to the first socket 50 but can connect to the second socket 80. In one presently preferred arrangement, each backrest assembly cannot be placed in the receptacle for the other backrest assembly. In other words, the sizes, shapes and/or configurations of each backrest assembly and socket are such that the backrest only first into the socket it is designed for.

Before describing the first backrest assembly 110 in detail, the second backrest assembly 112 will be described in detail. With reference to FIG. 10, the second backrest assembly 112 generally comprises a support 120 and a support bracket 122. The illustrated support 120 comprises a lower tab 124, a main body 126 and an elongated neck region 128. The tab 124, main body 126 and neck region 128 preferably are integrally formed (i.e., monolithic). In some arrangements, separate components can be provided and secured together in suitable manners.

In the illustrated arrangement, however, the lower tab 124 and the neck region 128 are generally linear but offset from each other with the main body 126 connecting the neck region 128 to the lower tab 124 and, therefore, comprising a pair of bends. In particular, the main body 126 defines an enclosed angle of about 133 degrees with the lower tab 124 at one end and with the neck region 128 at the other. Other angles can be used but the illustrated angle provides sufficient offset between the lower tab 124 and the neck region 128 in both the horizontal and vertical directions.

The lower tab 124 has a first width W1 that is less than a second width W2 defined by the main body 126. Thus, a shoulder 130 is defined at an intersection of the lower tab 124 and the main body 126. The shoulder 130 helps to properly locate the tab 124 within the receptacle 88 of the second socket 80. To further assist with insertion of the tab 124 into the receptacle 88, the lowermost portion of the tab 124 features chamfered corners 131. The tab 124 also preferably comprises a threaded hole 132. When the tab 124 is properly located within the receptacle 88, the threaded hole 132 advantageously is aligned or substantially aligned with the aligned holes 96 of the second socket 80. Such a configuration allows a locking member, such as a threaded fastener 134, to secure the tab 124, and thereby the support 120, to the second socket 80. In one preferred arrangement, the threaded fastener 134 is a button-head screw with an internal hex feature.

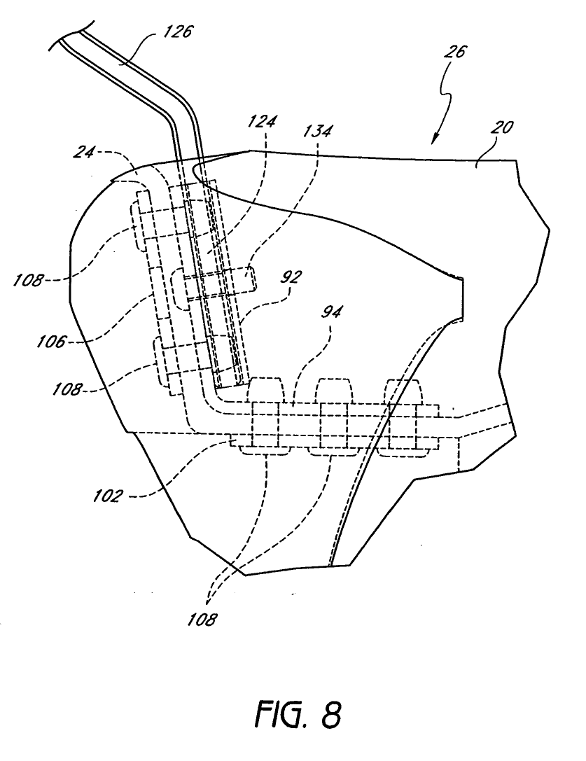

Preferably, the threaded fastener 134 can be tightened into the second socket 80 with the head of the fastener 134 passing through the enlarged opening 106 (see FIG. 8). In the illustrated arrangement, the fastener 134 is a button head screw. In other arrangements, the fastener 134 can be a set screw, a hex head screw or other suitable threaded member. In some arrangements, the head of the fastener 134 can be drawn up tight against the upper backing plate 100 rather than passing through the upper backing plate 100. Such arrangements are less advantageous, however, in that repeated loading and unloading of the base member 24 located between the second socket 80 and the upper backing plate 100 can reduce the life expectancy of the base plate. Therefore, by directly tightening against the second socket 80, the forces that result from the threaded fastener 134 being inserted and removed while the second backrest assembly 112 is in use or not in use can be directed solely to the socket 80 and not directly transmitted to the base member 24.

With reference again to FIG. 10, the illustrated arrangement of the support 120 admits to formation from flat bar stock. In one preferred configuration, the support 120 is stamped from ¼ inch steel flat bar. In other arrangements, the support 120 can be formed of ⅜ inch or 5/16 inch flat. In yet other arrangements, the support 120 can be formed of other materials and/or have other thicknesses. Advantageously, however, the use of a flat stock material decreases material costs while increasing the flexibility of the support 120 relative to square tube stock or the like. Thus, the support 120 can help absorb some vibration energy transmitted from the base member 24 to the second backrest assembly 112.

To further enhance the vibration absorption, and to provide improved flexure during use, the neck region 128 of the support 120 has a reduced width W3 relative to the main body 126. More preferably, the neck region 128 of the support 120 has a reduced width relative to the tab 124. In the illustrated arrangement, a smooth transition between the width of the main body 126 and the width of the neck region 128 is provided by a pair of radiussed cutouts 136. The radiussed cutouts 136 reduce the stress-raisers otherwise created by sharp dimensional changes. Other transitions also can be used, if desired. The reduced width of the neck region 128 improves flexibility in the fore and aft directions, flexibility in the lateral directions as well as flexibility in torsion.

The end of the neck region 128 supports a head 140. The illustrated head 140 is generally cylindrical with a through bore 142. The head 140 is secured to the neck region 128 with a double fillet weld in one preferred configuration. The head 140 can be secured in any other suitable manner. The head 140 preferably has a width that is substantially the same as the width of the adjacent portion of the neck region 128.

The head 140 carries the support bracket 122. In the illustrated arrangement, the support bracket comprises a central portion 144 that is flanked by two flanges 146. The illustrated flanges have an enlarged dimension at an upper end that tapers to a smaller dimension at the bottom. Other configurations also can be used.

Two aligned openings 150 are defined in the flanges 146 such that one of the two openings 150 is formed in each of the flanges 146 whereby the center lines of the two openings 150 are substantially aligned. Additional openings 152 are formed through the central portion 144.

The aligned openings 150 receive a pin 154. The pin 154 preferably defines a hinge axis between the support bracket 122 and the support 120. In the illustrated arrangement, the hinge pin 154 is inserted through one of the openings 150, through a disc spring 156 (e.g., a Belleville washer), through the bore 142 in the head 140, through another disc spring 156 and through the other of the openings 150. Retaining members 160, such as E clips, snap rings, retaining rings, circlips or the like, can be used to secure the pin 154 in position.

While the illustrated arrangement features a single disc spring 156 disposed to each side of the head 140, other configurations are possible, including the use of multiple disc springs 156 and other suitable structures for increasing the frictional forces between the support bracket 122 and the support 120. Desirably, the disc springs 156 provide sufficient frictional forces between the support bracket 122 and the support 120 such that the bracket 122 can move relative to the support 120 while limiting such movement from being substantially free. Such an arrangement allows the relative position between the support and the bracket to be maintained without input from a rider. In other configurations, the pin 154 can be replaced by a threaded fastener such that the friction force between the bracket 122 and the support 120 can be increased in case frictional forces created at the disc spring 156 interfaces diminish over time.

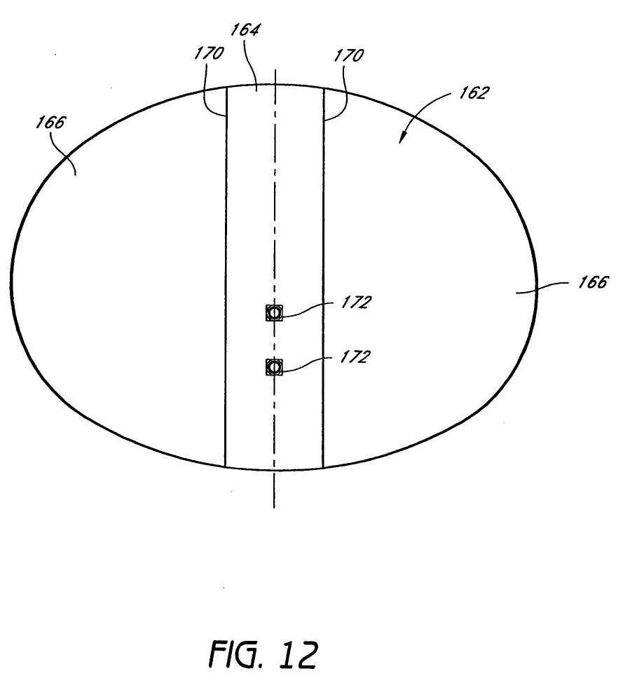

With reference now to FIG. 12, a backrest plate 162 comprises a central region 164 and a pair of wings 166. Each of the wings 166 preferably extend slightly forward at a respective break line 170. Other configurations of the backrest plate 162 also can be used. Moreover, while not illustrated, the backrest could comprise cut-outs or windows to reduce the weight of the backrest, for instance. Along the central region 164 of the illustrated backrest plate 162, a pair of weld nuts 172 can be secured in any suitable manner. In one arrangement, the weld nuts are secured with a continuous weld. More preferably, the weld nuts 172 receive a double fillet weld. In some configurations, the backrest plate 162 can be formed of fiberglass and threaded members (e.g., nuts, bolts or the like) can be molded into the plate or can have configurations such that the threaded members are embedded or otherwise fixed to the backrest plate (e.g., riv-nuts and molded-in fasteners).

Each of the weld nuts 172 defines a threaded opening that receives a threaded fastener 174 (see FIG. 10). The threaded fastener 174 extends through one of the openings 152 in the support bracket 122. Thus, the threaded fasteners 174 can secure the backrest plate 162 to the support bracket 122, which secures it to the support 120, which secures it to the second socket 80, which secures it to the rest of the saddle seating assembly 10. Other manners of securing the backrest plate 162 to the support bracket 122 also can be used. For instance but without limitation, threaded stubs can be secured to the backrest plate 162 and nuts or the like can be used to secure the backrest plate 162 to the bracket 122. Advantageously, the position of the connection between the backrest plate 162 and the bracket 122 is in midspan of the height of the backrest plate 162. Thus, the backrest plate angular position can be more easily adjusted and maintained due to improved balance over arrangements in which the backrest plate is supported at a lower region of the plate.

With reference now to FIG. 6, the first backrest assembly 110 will be described in detail. Generally speaking, the first backrest assembly 110 differs from the second backrest assembly 112, which was described above, in that the first backrest assembly 110 is designed with a support 175 that has an upper portion 176 that pivots relative to a lower portion 178. The lower portion 178 of the support 175 of the first backrest assembly 100 generally comprises a tab 180 while the upper portion 176 of the support 175 generally comprises a neck region 182.

The tab 180 and the neck region 182 are joined by a two piece main body 186. The main body 186 comprises a lower portion 190 and an upper portion 192. The lower portion 190 preferably is joined with the tab 180. In some configurations, the lower portion 190 and the tab 180 are integrally formed (i.e., monolithic). The lower portion 190 comprises a bent region such that a segment 194 of the lower portion 190 extends at an angle relative to the tab 180. Thus, the tab 180 and the lower portion 190 together define an L-shaped component.

Two hinge lugs 196 extend upward from the lower portion 190 proximate the bent region. The segment 194 extends beyond the lugs 196 when viewed from a plane parallel to the segment 194. The lugs 196 in the illustrated arrangement are generally cylindrical components with central apertures 200.

The lower tab 180 has a first width X1 that is less than a second width X2 defined by the lower portion 190 of the main body 186. Thus, a shoulder 202 is defined at an intersection of the lower tab 180 and the lower portion 190 of the main body 186. As described above, the shoulder 202 helps to properly locate the tab 180 within the receptacle 58 of the first socket 50. The lowermost portion of the tab 180 also features chamfered corners 204.

The tab 180 also preferably comprises a threaded hole 206. When the tab 180 is properly located within the receptacle 58, the threaded hole 206 advantageously is aligned or substantially aligned with the aligned holes 66 of the first socket 50. Such a configuration allows a locking member, such as a threaded fastener 208, to secure the tab 180, and thereby the support 175, to the first socket 50. In one preferred arrangement, the threaded fastener 208 is a button-head screw with an internal hex feature.

Preferably, the threaded fastener 208 can be tightened against the first socket 50 with the head of the fastener 208 passing through the enlarged opening 76. In some arrangements, however, the head of the fastener 208 can be drawn up tight against the upper backing plate 70 rather than passing through the upper backing plate 70. As described above, such arrangements are less advantageous. Therefore, by directly tightening against the first socket 50, the forces that result from the threaded fastener 208 being inserted and removed while the first backrest assembly 110 is in use or not in use can be directed solely to the socket and not transmitted to the base member 24.

The neck region 182 of the support 175 has a reduced width relative to the upper portion 192 of the main body 186. More preferably, the neck region 182 of the support 175 has a reduced width relative to the tab 180. In the illustrated arrangement, a smooth transition between the width of the upper portion 192 of the main body 186 and the width of the neck region 182 is provided by a pair of radiussed cutouts 210. The radiussed cutouts 210 reduce the stress-raisers otherwise created by sharp dimensional changes. Other transitions also can be used, if desired. The reduced width of the neck region 182 improves flexibility in the fore and aft directions, flexibility in the lateral directions as well as flexibility in torsion.

The lower end of the neck region 182 is connected to the upper portion 192 of the main body 186. In the illustrated arrangement, the neck region 182 and the upper portion 192 of the main body 186 are integrally formed although they need not be so. Moreover, in some arrangements, the upper portion 192 of the main body 186 can be omitted with the neck region 182 being pivotally connected to lower portion 190 of the main body 186. Furthermore, in some arrangements, the lower portion 190 of the main body 186 can be omitted with the tab 180 being pivotally connected to the upper portion 192 of the main body 186. Even further, in some arrangements, the tab 180 can be directly pivotally connected to the neck region 182 or the pivotal connection can be positioned along the neck region.

By providing the pivotal connection at the interface between the lower portion 190 and the upper portion 192, the pivotal connection can be recessed into the saddle 26 when the first backrest assembly 112 is mounted to the saddle 26. The upper portion 192 of the main body 186 comprises a bent region such that a segment 212 of the upper portion 192 extends at an angle relative to the neck region 182. Thus, the neck region 182 and the upper portion 192 together define an L-shaped component. Preferably, the segment 212 of the upper portion 192 is shorter than the segment 194 of the lower portion for reasons that will become apparent.

Two hinge lugs 214 extend outward from the end of the segment 212 of the upper portion 192. The lugs 214 in the illustrated arrangement are generally cylindrical components with central apertures 216. A pin 220 couples the hinge lugs 214 to the hinge lugs 196 and defines a pivot axis about with the upper portion 192 can pivot relative to the lower portion 190. The pin 220 can have any suitable configuration and can be made of any suitable material. In the illustrated arrangement, the pin 220 is formed of 304 stainless steel and has grooves formed at each end.

The pin 220 also supports a spring collar 222 that is positioned between the two pairs of lugs 196, 214. The spring collar 222, in turn, supports a torsion spring 224. The torsion spring 224 defines a biasing member that urges the segment 194 of the lower portion 190 toward a lower surface of the upper portion 192. In other words, the illustrated torsion spring 224 has a first leg 226 and a second set of legs 228 with the first leg 226 engaged on an upper surface of the segment 212 of the upper portion 192 and the second set of legs 228 abutting the lower portion 190 (see FIG. 6).

The pin 220 is secured in position with a pair of retaining members 230. The retaining members 230 can have any suitable configuration. In the illustrated arrangement, the retaining members 230 are E clips; however, the retaining members can be circlips, snap rings, retaining rings or the like.

As best illustrated in FIG. 3, a threaded member 236 extends into a threaded aperture 238 formed in the segment 194 of the lower portion 190. The threaded member 236 preferably is a button head screw and can function as a stop to limit the movement of the seat back in a direction toward the passenger seat portion 20 of the saddle 26. In other arrangements, other suitable components, such as bolts, set screws, other threaded members, or the like can be used as the threaded member 236. Advantageously, the head of the illustrated threaded member is positioned between the segment 194 and the opposing segment 212 such that adjustment of the threaded member 236 into and out of the aperture 238 can be used to alter the seated position of the two segments 194, 212. Moreover, the placement of the threaded member 236 facilitates adjustment without removing the seat (e.g., the seat can be folded forward while the threaded member 236 is turned to adjust the position). By adjusting the seated position of the two segments 194, 212, the relative angle between the upper portion 176 of the support 175 and the lower portion 178 of the support 175 can be adjusted. This adjustment of the relative angle can be used to move the backrest of the first backrest assembly 110 forward by about 50 mm such that the backrest can be adjusted forward to accommodate riders of different sizes.

The end of the neck region 182 supports a head 240. The illustrated head 240 is generally cylindrical with a through bore 242. The head 240 is secured to the neck region 182 with a double fillet weld in one preferred configuration. The head 240 can be secured in any other suitable manner. The head 240 preferably has a width that is substantially the same as the width of the adjacent portion of the neck region 182.

The head 240 carries a support bracket 243. In the illustrated arrangement, the support bracket 243 comprises a central portion 244 that is flanked by two flanges 246. The illustrated flanges 246 have an enlarged dimension at an upper end that tapers to a smaller dimension at the bottom. Other configurations also can be used.

Two aligned openings 250 (one shown) are defined in the flanges 246 such that one of the two openings 250 is formed in each of the flanges 246 whereby the center lines of the two openings 250 are substantially aligned. Additional openings 252 are formed through the central portion 244. These openings 252 can be used to secure the backrest plate 162 (see FIG. 12) to the support bracket 243 in manners such as those described above, such as the use of threaded fasteners 253.

The aligned openings 250 receive a pin 254. The pin 254 preferably defines a hinge axis between the support bracket 243 and the support 182. In the illustrated arrangement, the hinge pin 254 is inserted through one of the openings 250, through a disc spring 256 (e.g., a Belleville washer), through the bore 242 in the head 240, through another disc spring 256 and through the other of the openings 250. Retaining members 260, such as E clips, snap rings, retaining rings, circlips or the like, can be used to secure the pin 254 in position.

While the illustrated arrangement features a single disc spring 256 disposed to each side of the head 240, other configurations are possible, including the use of multiple disc springs 256 and other suitable structures for increasing the frictional forces between the support bracket 243 and the support 182. Desirably, the disc springs 256 provide sufficient frictional forces between the support bracket 243 and the support 182 such that the bracket 243 can move relative to the support 182 while limiting such movement from being substantially free. Such an arrangement allows the relative position between the support and the bracket to be maintained without input from a rider. In other configurations, the pin 254 can be replaced by a threaded fastener such that the friction force between the bracket 243 and the support 182 can be increased in case frictional forces created at the disc spring 256 interfaces diminish over time.

As with the support 120, the tab 180, the support 182 and the upper and lower portions 190, 192 of the main body admit to formation from flat bar stock. In one preferred configuration, these components can be stamped from ¼ inch steel flat bar. In other arrangements, these components can be formed of ⅜ inch or 5/16 inch flat. In yet other arrangements, these components can be formed of other materials and/or have other thicknesses. Advantageously, however, the use of a flat stock material decreases material costs while increasing the flexibility of the support 120 relative to square tube stock or the like. Thus, the support 120 can help absorb some vibration energy transmitted from the base member 24 to the second backrest assembly 112. In some configurations, the lower portion 178 can be formed of flat bar while the upper portion 176 can be formed of other materials.

The reduced dimension in the longitudinal plane of the motorcycle that results from the use of flat bar allows increased padding to be positioned in the vicinity of the backrest assemblies 110, 112. More particularly, as compared to prior configurations that featured tubular backrest posts and/or bulky receive sockets, the illustrate arrangement allows positioning of thicker padding in a region of the seat that supports a rider's tailbone. Thus, a more comfortable seat results.

With reference now to FIG. 2, additional relationships that further increase the comfort and functionality of the illustrated saddle seat assembly 10 will be described. First, as illustrated, a distance O is defined between an uppermost surface of the saddle 26 and a centerline of the hinge pin 220 of the support 182. Preferably, the offset defined by the segment 212 of the upper portion 192 from the hinge pin 220 is greater than or equal to the distance O. Thus, the length from the forward face of the support 182 to the axis defined by the hinge pin 220 can be sufficient to allow the first backrest assembly 110 to fold substantially flat to the seat. In other words, as illustrated in FIG. 2, the distance from the top of the saddle 26 preferably is less than or equal to the sum of the length of the segment 212 (i.e., the distance from the backside of the neck region to the pivot axis) and the distance from the pivot axis to the top of the socket 50. Such a configuration improves the ability of passengers to get on and off of the saddle 26 because the first backrest assembly 110 can be folded to a position generally at or below the height of the intermediate region defined between the passenger seat portion 20 and the driver seat portion 18 of the saddle 26. In other words, the first backrest assembly 110 can be folded forward to be substantially flush with the intermediate portion of the saddle 26.

With continued reference to FIG. 2, an upper end of the receptacle 88 is positioned vertically lower than a portion of the base member 24 located between the passenger seat portion 20 and the driver seat portion 18 of the saddle 26. In the illustrated arrangement, the receptacle 88 also is positioned rearward of a generally vertical and substantially transverse plane A. The plane A is defined through a rearmost portion of the driver seat portion 18 of the saddle 26. In particular, the plane A extends through a portion of the saddle 26 that is not designed to support the weight of the rider but that is designed as more of a back support. Moreover, the receptacle 88 is positioned forward of a plane B, which is generally parallel to the plane A but which extends through the intersection of the uppermost surface of the saddle 26 and the support 182. Furthermore, the entire socket 80, including the receptacle 88, is positioned rearward of a transverse plane D that extends along the most forward portion of the backrest and the most rearward portion of the driver seat portion 18 of the saddle 28. Thus, because of its placement, orientation and sizing, the receptacle 88 does not significantly impede into regions that require significant padding. As such, the cushioning used by the rider and/or a passenger can be maximized while still providing the ability to have removable and/or foldable backrests.

Similarly, a transverse plane C that extends generally parallel with the support 128 is shown in FIG. 2. The plane C defines a region to its rear that seldom is used by a passenger. As illustrated, the receptacle 58 of the second backrest assembly 112 is positioned to the rear of the plane C. Moreover, the entire socket 50 is positioned to the rear of the plane C. Thus, the socket 50 and/or the receptacle 58 is positioned to be outside of the region commonly used to support a passenger. As such, the cushioning used by the passenger can be maximized while still providing the ability to have removable and/or foldable backrests.

During manufacturing, the base member 24 first is formed. In the illustrated arrangement, the base member 24 is formed by hand-laid fiberglass. The fiberglass is then cured and holes are provided in the base member. The sockets 50, 80 are positioned on the inside of the base member 24 and the backing plates 70, 72, 100, 102 are positioned on the outside of the base member 24. The backing plates 70, 72 are joined to the socket 50 and the backing plates 100, 102 are joined to the socket 80 with suitable fasteners. In the illustrated arrangement, the components are joined with pop rivets 78, 108. With the sockets 50, 80 installed, cores are positioned on the inside of the base member 24 and the openings in the sockets 50, 80 (e.g., the receptacles 58, 88) are covered. The base member 24 is placed in a mold and foam is applied to the inside of the base. The foam is then cured and a seat cover, made from cloth, leather, vinyl or another suitable material is applied over the foam. The cores are used to ensure a clear passage through the seat cushion material to the sockets 50, 80. The passages can be covered, when not in use, with small flaps of seat cover material.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A backrest for a saddle seat assembly comprising a backplate, said back plate coupled to a support, said support being configured for removable insertion into a saddle seat, said support comprising a first portion and a second portion with said first portion and said second portion being pivotally connected.

2. A saddle seat assembly for a vehicle, said saddle seat assembly comprising a seat base and a seat cover, a socket being positioned between said seat base and said seat cover, said socket having an upper surface through which a receptacle is defined, a seat backrest comprising a support, said support having a portion that is insertable through said seat cover into said receptacle of said socket, said portion of said support comprising a first portion and a second portion that are connected at a pivot axis, said first portion being generally horizontally offset from said second portion a first distance, said pivot axis being generally vertically spaced from said upper surface of said socket by a second distance and said upper surface of said socket being generally vertically spaced from said seat cover by a third distance, said third distance being less than or equal to a sum of said first distance and said second distance.

3. A saddle seat assembly for a vehicle, said saddle seat assembly comprising a seat base, said seat base having an inside surface and an outside surface, said inside surface corresponding to a side that will support a foam component, said seat base defining an intermediate recess, a first socket positioned proximate said intermediate recess on said inside surface side of said seat base, a first backing plate positioned proximate said intermediate recess on said outside surface side of said seat base, said first socket and said first backing plate being joined by fasteners, said first socket comprising a generally upwardly disposed opening receptacle, said receptacle being adapted to removably receive a seat back assembly.

4. The assembly of claim 1, wherein said fasteners comprise pop rivets.

5. The assembly of claim 1, wherein said socket is positioned vertically lower than an uppermost portion of an intermediate region of said seat base.

6. The assembly of claim 1 further comprising a first seat back assembly, said first seat back assembly comprising a tab, said tab being insertable into said first socket.

7. The assembly of claim 6, wherein said first seat back assembly further comprises a neck region, said neck region being moveable relative to said tab.

8. The assembly of claim 7, wherein said tab and said neck region are connected by a main body.

9. The assembly of claim 8, wherein said main body comprises an upper portion and a lower portion, said upper and lower portions being pivotally connected.

10. The assembly of claim 9 further comprising a pin that joins said upper portion and said lower portion.

11. The assembly of claim 10 further comprising a torsion spring that biases said upper portion to a first position relative to said lower portion.

12. The assembly of claim 11, wherein said first position is adjustable.

13. The assembly of claim 12 further comprising a threaded fastener that is connected to said lower portion of said main body, whereby movement of an end of said threaded fastener up and down relative to said lower portion of said main body results in adjustment of said first position.

14. The assembly of claim 7, wherein said neck region has a reduced width relative to said tab.

15. The assembly of claim 7, wherein a fastener removably secures said tab to said socket.

16. The assembly of claim 7, wherein said tab and said neck region are pivotally connected at a hinge and said hinge is positioned within said saddle.

17. The assembly of claim 1, wherein said socket comprises a receptacle that has a first dimension less than about 10 mm.

18. The assembly of claim 17, wherein said first dimension is less than about 8.2 mm.

19. The assembly of claim 18, wherein said first dimension is less than or equal to about 6.9 mm.
